(19) United States
(12) Patent Application Publication
(10) Pub. No.: US 2003/0025317 A1
(43) Pub. Date: Feb. 6, 2003

(54) Flexible see-through bound document assembly

(76) Inventors: Norman Yamamoto, Yorba Linda, CA (US); Adam G. Bratter, Newport Coast, CA (US)

Correspondence Address: OPPENHEIMER WOLFF & DONNELLY LLP, 38th Floor, 2029 Century Park East, Los Angeles, CA, 90067-3024, US

(21) Appl. No.: 09/921,734

(22) Filed: Aug. 3, 2001

(51) Int. Cl. B42D 3/00

(52) U.S. Cl. 281/31

(57) ABSTRACT

A semi-flexible binder has a transparent cover with a frame coated on it and a pocket on the inside of the cover to retain visual material to be seen from the front of the binder. The pocket sheet material may be secured along two edges of the cover to facilitate quick insertion of the visual material. Also included are (1) computer aided preparation of visual material; (2) a partial pocket integral with the rear cover; and (3) optional index dividers.

### BACKGROUND OF THE INVENTION

1. Field of the Invention

This invention relates to an inexpensive flexible binder assembly with a professional appearance.

2. Background of the Invention

Conventional hard bound binders with view windows are disclosed in prior art patents such as U.S. Pat. Nos. 5,857,797, 5,876,143 and 6,206,602B1; and sheet protectors with cut-away arrangements are also known, see U.S. Pat. No. 6,012,86.

### INVENTION SUMMARY

However, there is a need for a simple inexpensive flexible binder which is easy to prepare, and which has a high quality, professional appearance.

In accordance with one illustrative embodiment of the invention, this object is achieved by the provision of a flexible binder, with a transparent flexible front cover with a frame in the form of a coating. On the inside of the front cover a plastic pocket is provided, and it is firmly secured to the front cover along two edges, with the two other edges of the pocket being free so that visual material may be readily inserted into the pocket.

The sheet material for the front cover pocket is preferably fairly thin as compared with the cover material; for example the covers may be formed of polypropylene or a blend thereof, in the order of 17 mils thick, while the sheet plastic material for the pocket may be in the order of 7 or 8 mils thick. The pocket is preferably bonded to the inside of the cover just outside the frame, and is slightly larger than standard 8½×11 inch or A-4 paper. The pocket may be secured along only two edges, the bottom and outer edge, away from the intended binding location, or it may be secured on three sides excluding the top. With this latter construction, it may be cut near but spaced from the binding from the top to near the bottom adjacent the binding. With either construction the sheet bearing the visual material may be readily slipped into place, and the latter construction will have the residual edge of the pocket overlapping the inner edge of the visual material. The pocket may also be secured to the front cover on three sides, with the flexibility of the covers permitting easy insertion of the visual material through the open side, which may be on any side of the pocket.

An image of the cover of the binder, showing the frame, or merely an outline or template of the printable area of the frame, may be provided on a computer monitor, and the user may introduce suitable visual material into the area within the frame, and then print out the desired image for insertion into the pocket.

The binder may include additional tabbed index sheets, opaque or optionally translucent or transparent, permitting the use of additional visual display sheets to introduce each section of the bound material.

The rear cover is also flexible and may be provided with a partial pocket extending for less than half of the area of the rear cover; and this partial pocket may be formed from an over-size sheet of the back cover sheet material folded to form the rear pocket. The rear pocket may be heat formed, or folded using a score cut and pressure, and glued or adhesively secured to form the pocket. The rear pocket sheet material may optionally be provided with cuts for holding the corners of a business card or the like.

The rear cover is preferably printed with a dark colored coating, preferably matching the frame on the front cover, but the inner rear partial pocket is preferably transparent so that its contents may be viewed.

Other objects, features and advantages of the invention will become apparent from a consideration of the following detailed description and from the accompanying drawings.

### BRIEF DESCRIPTION OF THE DRAWINGS

FIG. 1 is a plan view of a flexible view binder illustrating the principles of the present invention;

FIG. 2 is a perspective view of the binder of FIG. 1 with a binder shown with the front cover open and visual material being inserted into the pocket on the inside of the cover;

FIG. 3 shows a computer terminal including a monitor, a keyboard, and a printer, for forming the visual material to be inserted into the cover of the binder of FIGS. 1 and 2;

FIG. 4 is a diagram showing the securing of a pocket to the inside of the front cover of the binder of FIGS. 1 and 2;

FIG. 5 shows the binder of FIGS. 1 and 2 with the front cover open and with tabbed dividers being exposed;

FIG. 6 is a diagramatic showing of the plastic sheet blank employed in forming the back cover, and the resultant back cover with a pocket formed from the single sheet; and

FIG. 7 is an inner view of the rear cover of the binder showing the partial pocket.

### DETAILED DESCRIPTION OF THE PREFERRED EMBODIMENTS

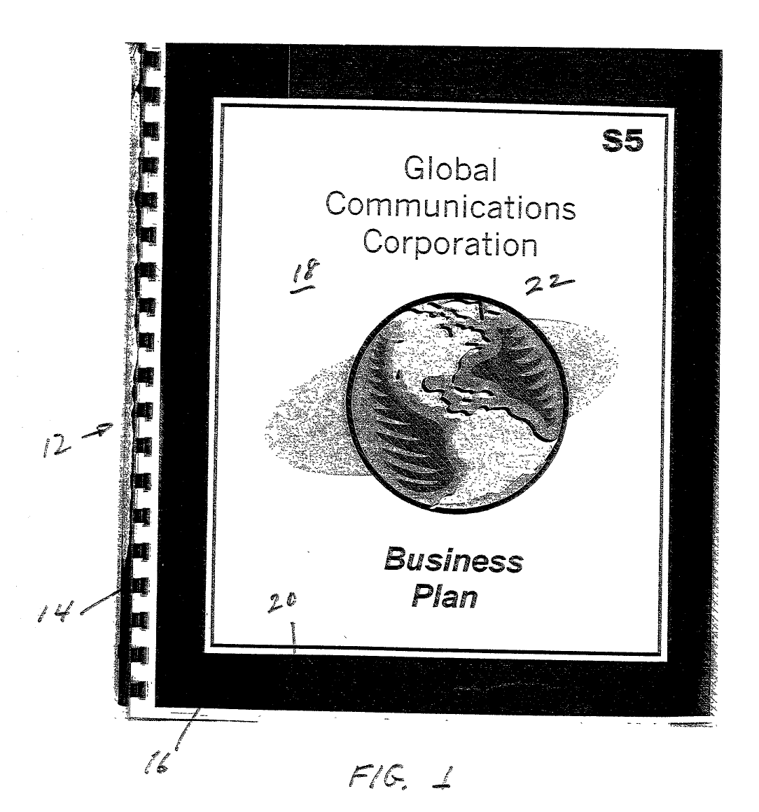

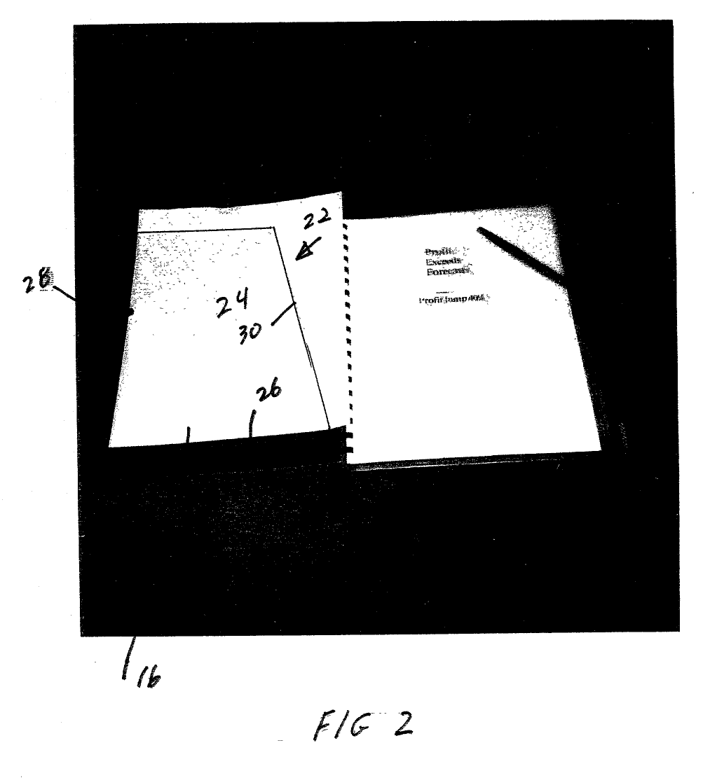

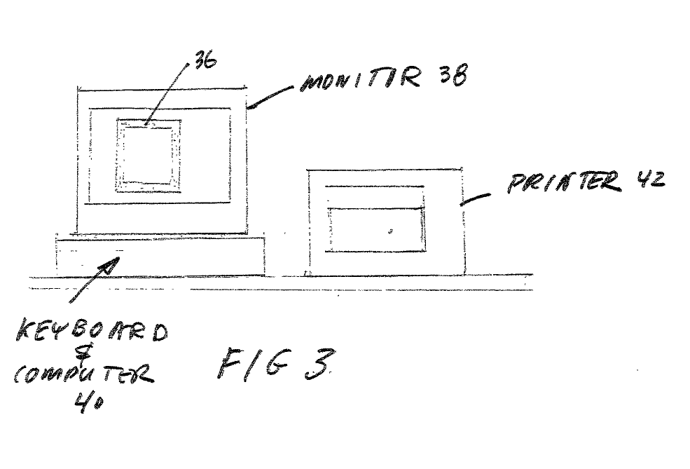

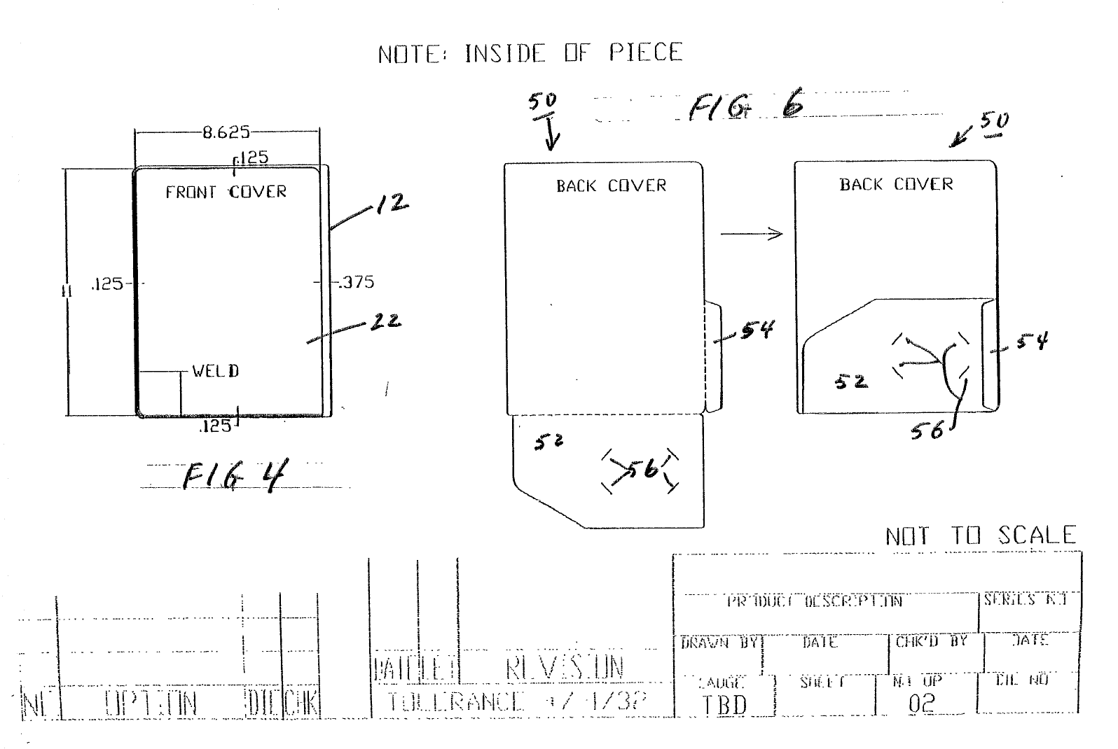

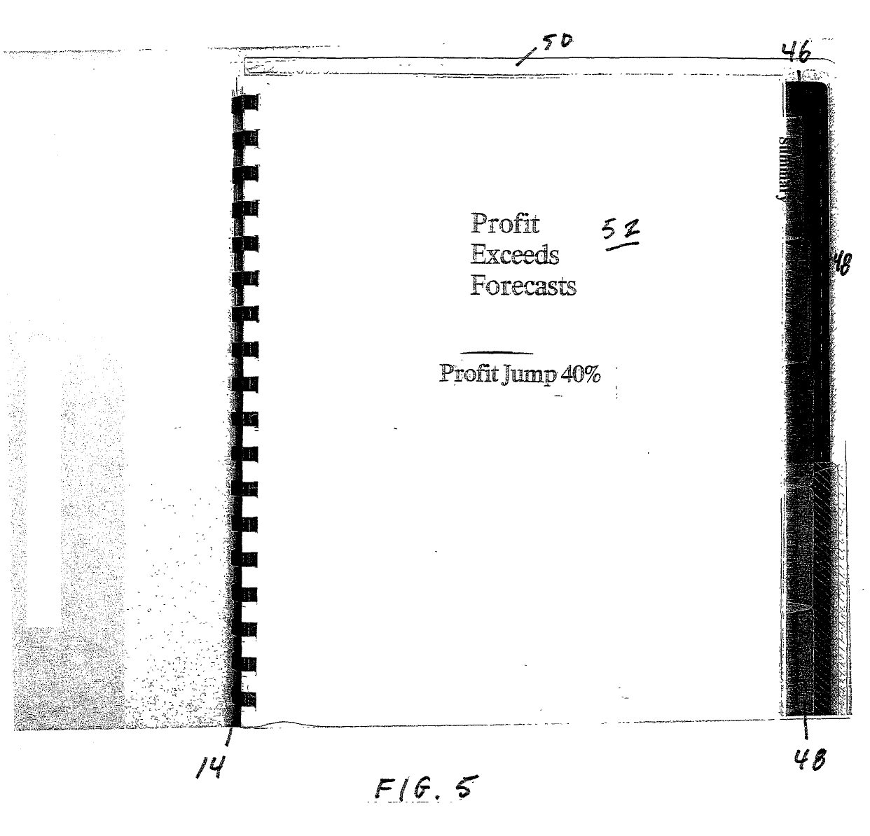

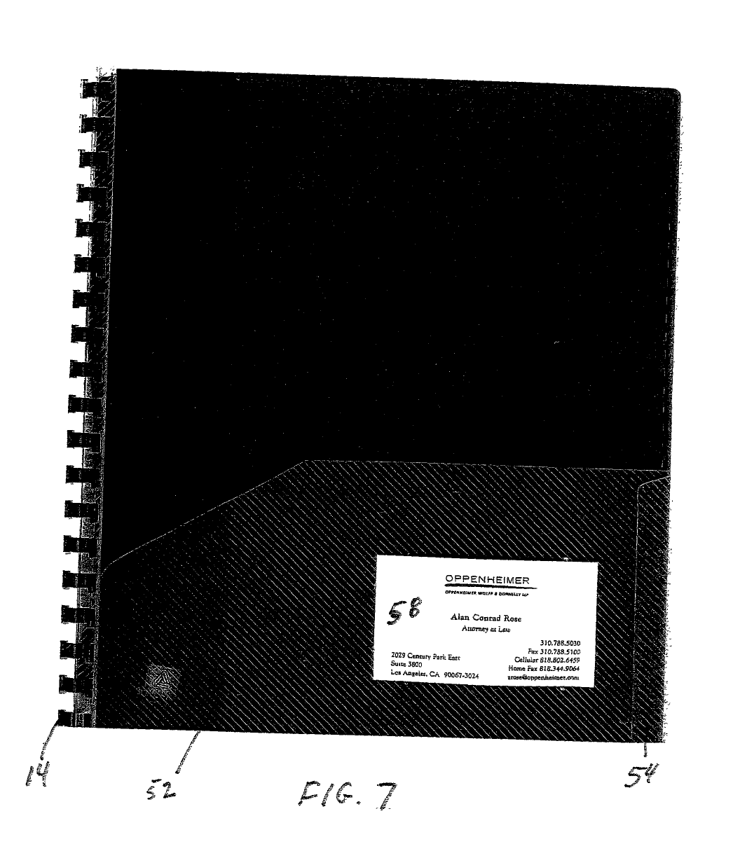

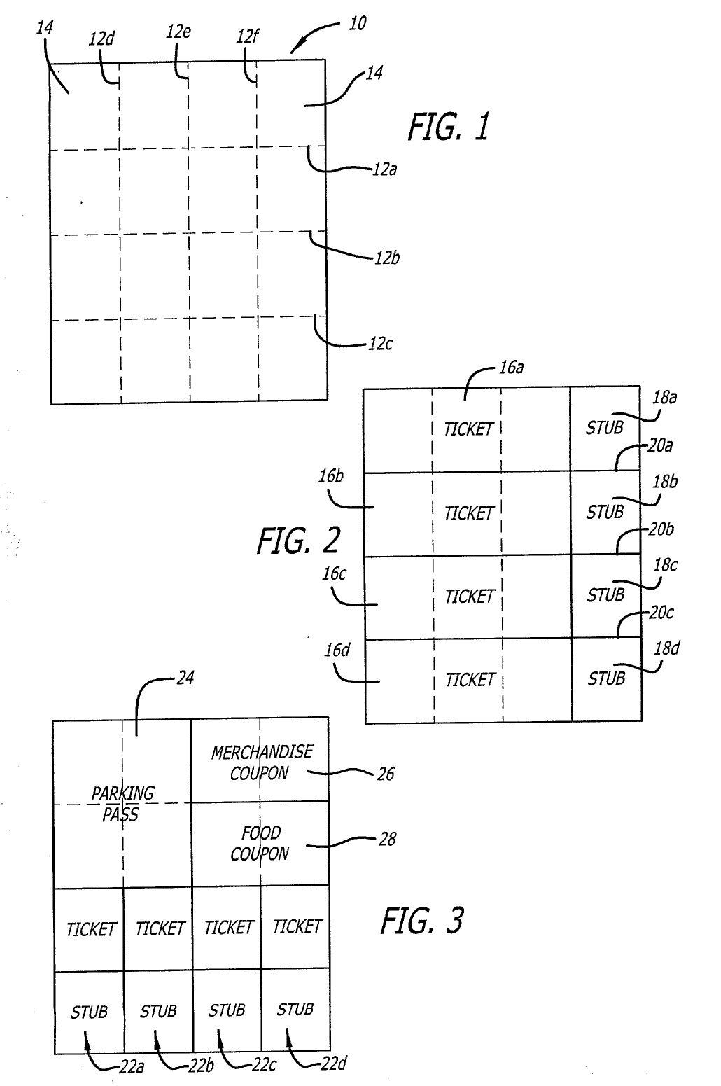

Referring now to FIG. 1 of the drawings, a flexible view cover binder 12 is shown. The binder 12 includes a comb type binding 14, and a front cover 16 which may be formed of flexible plastic material such as polypropylene. The polypropylene is flexible, but still firm enough to maintain the form of a binder and may, for example, be formed of textured transparent polypropylene in the order of 15 to 20 thousandths of an inch thick. The cover 16 includes a central transparent area 18, and an opaque or very dark colored coating 20 which forms a frame through which a visual insert 22 may be seen.

Referring to FIG. 2, this view of the binder shows the binder with the front cover open, and the insert 22 being slid into a pocket 24 as indicated by the arrow. The pocket 24 is of relatively thin flexible plastic, and is securely bonded to the cover 16 of the binder 12 along the lower edge 26 and the outer edge 28 of the binder. As shown in FIG. 2 of the drawings, the pocket 24 may be initially bonded to the inner surface of the cover 16 along three edges, with the top edge remaining open; and then a cut 30 may be made so that the visual insert 22 may be more easily and quickly inserted into the pocket. Following insertion within the visible portion of the pocket as shown in FIG. 2, the residual portion, not shown in FIG. 2, is flipped out and completes the retention of the visual material 22 within the pocket.

Reference is now made to FIG. 3 of the drawings indicating how the visual material 22 may be conveniently prepared for insertion in the pocket 24, with the visual material properly centered within the frame 20 which has been coated onto the cover 16. As indicated in FIG. 3, an image 36 of the framed front cover of the binder is displayed on the monitor 38. Alternatively, as noted above, a line outline or template of the “printable” area of the frame may be displayed. Also shown in FIG. 3 are the keyboard and computer unit 40 and the printer 42. The image 36 may be provided by one or more of any of a number of avenues including downloading from the internet from an Avery website, or alternatively may be provided from a compact disc containing appropriate data for producing the image 36. Using the keyboard 40, and/or images from existing files or from the web, the operator may prepare suitable visual material to be printed onto the visual insert 22, to provide an appearance such as that shown in FIG. 1 of the drawings.

Incidentally, with regard to dimensions, it is noted that the pocket is preferably of such a size that it will easily accommodate 8½×11 inch sheets. It is also noted that some transparent tabbed dividers may be employed for the contents of the binder. Accordingly, the front and rear covers of the binder may be approximately 9½×11½ inches in size; and the size of the pocket may be approximately 9×11 inches.

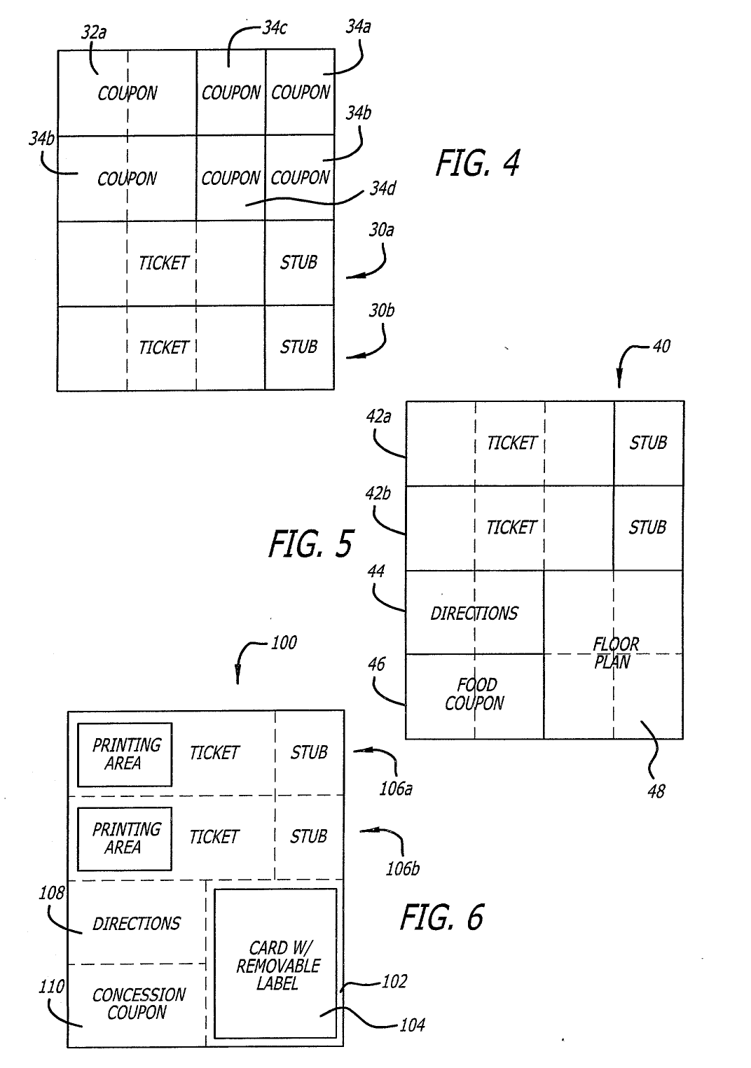

In FIG. 4 of the drawings, the inner pocket 22 is shown bonded to the cover 12 along the bottom and left hand edge, with the top and right hand edge being free for rapid loading of the visual insert sheet. This is a variation of the construction shown in FIG. 2, but in both cases the pocket has the upper edge and an inner edge free to permit rapid loading.

Now, turning to FIG. 5 of the drawings, the front cover has been turned back, and the comb type spine 14 is visible at the left in FIG. 5. The top sheet is a transparent divider sheet with a tab 46 which reads “Summary”. Other tabs 48 are also visible in FIG. 5 as is the upper edge of the rear cover 50 of the binder. The first heading sheet 52 behind the transparent index sheet 46 has the titles of the section on it; and in this case the title read “Profit Exceeds Forecast” and “Profit Jump 40%”. These titles may be on clippings secured to the heading sheet; or they may be printed directly on the heading sheet, but are visible through the tabbed binder sheet.

Reference is now made to FIG. 6 of the drawings which shows in the left hand view the shape of the rear cover 50 before it is folded to form the actual completed back cover, as shown in the right view of FIG. 6. In FIG. 6, the pocket 52 is initially folded up and heat formed into its folded position; and similarly the securing tab 54 is bent over on top of the outer edge of the pocket 52, folded, and then sealed, or bonded by adhesive, to the pocket portion 52. With both the back cover 50 and the pocket 52 being formed of fairly flexible but stiff polypropylene preferably between 0.015 and 0.020 inch thick, the pocket 52 is stiff enough to easily retain papers in the course of normal usage.

It may also be noted that the rear pocket 52 may be provided with a series of cuts 56 which are intended to retain a business card or other similar sized sheet material.

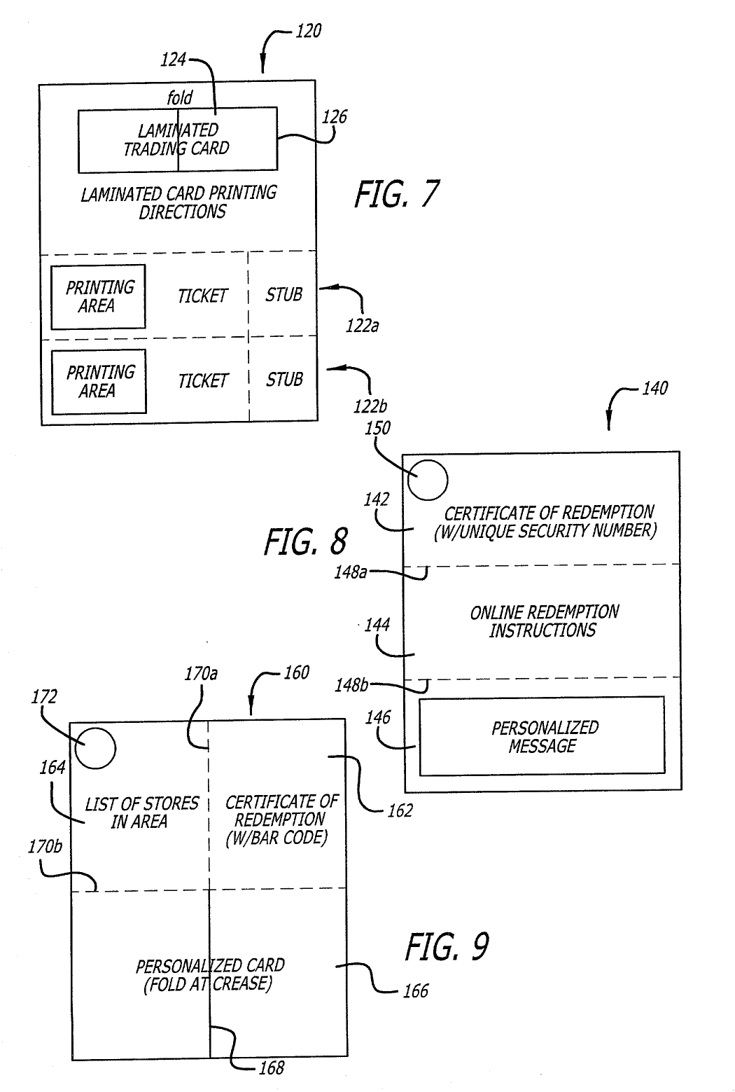

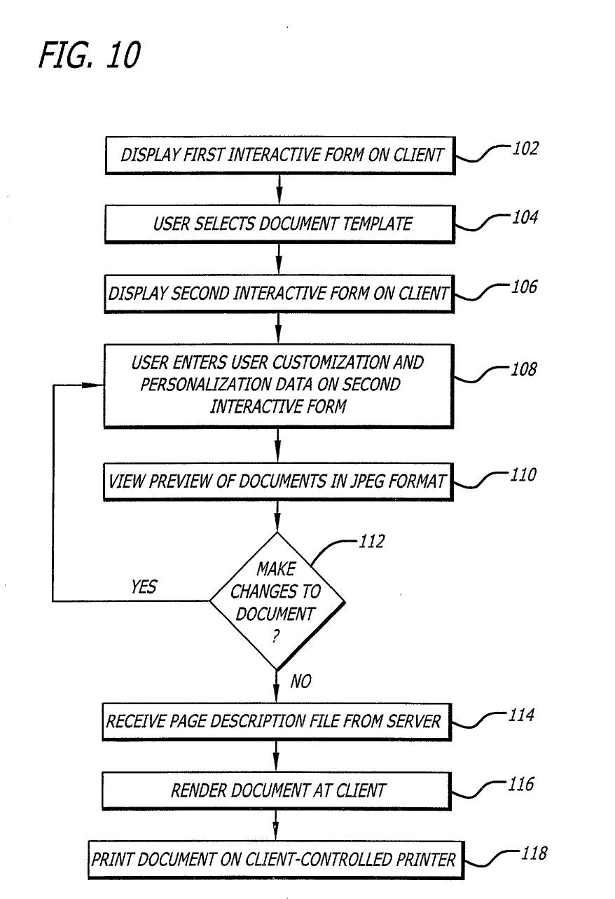

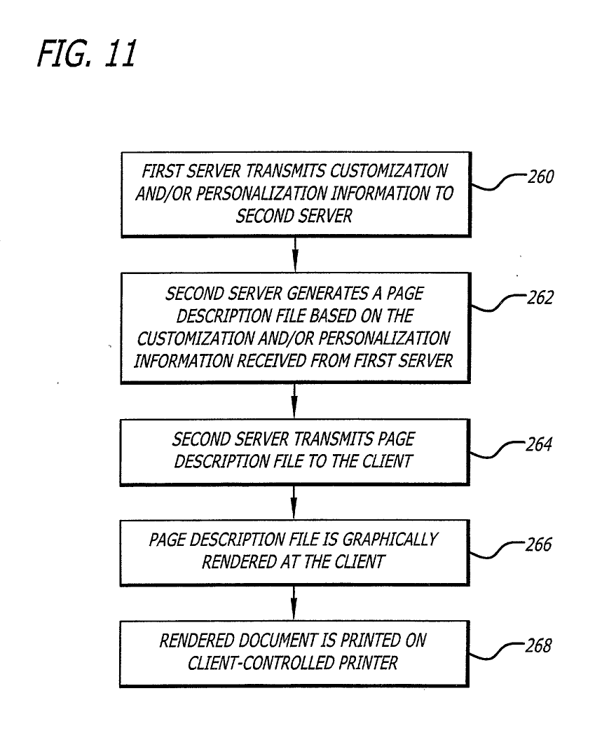

FIG. 7 is a print of the inside of the rear cover of the binder, with the comb binding element 14 shown at the left, and with the pocket 52 and the flap 54 visible in this showing. The opaque nature of the rear cover preferably having the same coloration as the frame on the front cover may also be noted. Business card 58 has been inserted into the slits 56.

In the present specification and claims the binder covers are sometimes referred to as being “semi-flexible”. In this regard, when the binder is rested on a flat surface and a pen is placed parallel to the spine of the binder between the cover and the remainder of the sheet material, the cover will flex so that the outer edge of the cover will just touch the remaining sheet material. As noted above, when textured polypropylene sheet material, about 15-20 mils thick is used, this type of semi-flexibility is achieved. Other plastic sheet material may be used with somewhat different stiffness and thickness to achieve the same semi-flexible results.

In conclusion, it is to be understood that the foregoing detailed description and the drawings illustrate the principles of the invention. However, various alternatives and modifications may be employed without departing from the spirit and scope of the invention. Thus, by way of example and not of limitation other types of bindings may be used instead of the plastic strip comb type binding shown. Plastic material other than polypropylene may be used. The binders may be formed to accommodate legal size or half sheet size paper. Accordingly, the invention is not limited to the specific embodiment shown in the drawings and described in detail herein.

We claim:

1. A semi-flexible cover-view binder assembly, comprising:
front and rear semi-flexible plastic covers, said front cover being provided with a peripheral substantially opaque frame;
an inner pocket secured to the inner surface of said front cover; said inner pocket being secured along its outer edge and its bottom edge, and permitting quick insertion of visual material from the top and inner areas of said pocket;
an insert having visual information applied thereto in the area within said frame, said insert being in said inner pocket;
a plurality of transparent dividers with tabs thereon mounted within said binder;
said rear cover having a partial pocket extending for less than half of the area of said rear cover; said partial pocket being formed of the same sheet as the rear cover, with the pocket being formed by folding a sheet upward and bonding it in place, said rear cover being coated with substantially opaque material similar to the frame coating on the front cover.

2. A binder assembly as defined in claim 1 where said inner pocket is secured to said front cover along three edges, with the upper edge of the pocket being open, and with the pocket being cut along the binding to facilitate rapid loading of visual material.

3. A binder assembly as defined in claim 1 wherein the inner pocket is bonded to the front cover at least along two edges.

4. A binder assembly as defined in claim 1 wherein said partial pocket is transparent.

5. A system including a binder assembly as defined in claim 1 further including a computer, a keyboard and a printer for displaying the framed front cover of said binder and forming visual material within said frame, and printing out the visual insert for insertion into the inner pocket with the visual material set-off and enclosed by said frame.

6. A binder assembly as defined in claim 1 wherein said rear cover partial pocket has a plurality of slits therein for mounting cards on said partial pocket.

7. A method for forming a semi-flexible cover-view binder comprising the steps of:
forming a semi-flexible front cover with a frame coating around the periphery thereof;
bonding a pocket formed of thin plastic material to the inside of said front cover;
providing an image of said front cover on a computer monitor, with the outline of the frame included in said image;
developing visual images to appear on said monitor in the area within the frame;
printing out an insert sheet with said developed images thereon;
mounting said insert sheet into said pocket so that said developed images are visible from the front of said binder.

8. A method as defined in claim 7 further comprising the step of assembling additional sheet material, and a semi-flexible back cover of material similar to the front cover, and binding the covers and sheet material together to form a complete binder.

9. A method as defined in claim 8 further comprising the step of forming a partial rear pocket on the inner surface of said rear cover by using oversize sheet material for said rear cover and pocket, and folding a portion of said oversize sheet over the remainder of said sheet to form said pocket, and securing said pocket to the remainder of said sheet to form a rear cover and pocket assembly.

10. A method as defined in claim 8 wherein said pocket is formed with two edges secured to said cover and with the top of said pocket and the side of said pocket toward the binding being free, to permit quick insertion of said insert.

11. A semi-flexible cover-view binder assembly, comprising:
front and rear semi-flexible plastic covers, said front cover being provided with a peripheral substantially opaque frame;
an inner pocket secured to the inner surface of said front cover; said inner pocket being secured along its outer edge and its bottom edge, and permitting quick insertion of visual material from the top and inner side of said pocket; and
an insert having visual information applied thereto in the area within said frame, said insert being in said inner pocket.

12. a binder assembly as defined in claim 11 wherein said rear cover has a rear pocket of the same material as the said rear cover; said rear pocket being formed of the same sheet as the rear cover, with the pocket being formed by folding said sheet and bonding it in place.

13. A binder assembly as defined in claim 11 where said inner pocket is secured to said front cover along three edges, with the upper edge of the pocket being open, and with the pocket being cut along the binding to facilitate rapid loading of visual material.

14. A binder assembly as defined in claim 11 wherein said rear pocket is transparent.

15. A system including a binder assembly as defined in claim 11 further including a computer, a keyboard and a printer for displaying the framed front cover of said binder and forming visual material within said frame, and printing out the visual insert for insertion into the inner pocket with the visual material set-off and enclosed by said frame.

16. A binder assembly as defined in claim 11 wherein said rear cover is opaque and wherein it has a coating to substantially match the frame on the front cover.

17. A semi-flexible cover-view binder assembly, comprising:
front and rear semi-flexible plastic covers, said front cover being provided with a peripheral substantially opaque frame;
an inner pocket secured to the inner surface of said front cover; said inner pocket being secured along its outer edge and its bottom edge, and permitting quick insertion of visual material from the top and inner areas of said pocket;
an insert having visual information applied thereto in the area within said frame, said insert being in said inner pocket;
a plurality of dividers with tabs thereon mounted within said binder;
said rear cover having a rear pocket formed of the same sheet as the rear cover.

18. A binder assembly as defined in claim 17 wherein said inner pocket is secured to said front cover along three edges, with the upper edge of the pocket being open, and with the pocket being cut along the binding to facilitate rapid loading of visual material.

19. A system including a binder assembly as defined in claim 17 further including a computer, a keyboard and a printer for displaying the framed front cover of said binder and forming visual material within said frame, and printing out the visual insert for insertion into the inner pocket with the visual material set-off and enclosed by said frame.

20. A binder assembly as defined in claim 17 wherein said rear pocket is formed from an oversize sheet with a first area folded up to form said pocket and a second area folded down to secure said pocket in its folded position.

21. A semi-flexible cover-view binder assembly, comprising:
front and rear semi-flexible plastic covers, said front cover being provided with a peripheral substantially opaque frame;
an inner pocket secured to the inner surface of said front cover; said inner pocket being secured along three edges with the flexibility of said binder assembly permitting quick insertion of visual material into said pocket; and
an insert having visual information applied thereto in the area within said frame, said insert being in said inner pocket.

22. A semi-flexible cover-view binder assembly, comprising:
front and rear semi-flexible plastic covers, said front cover being provided with a peripheral substantially opaque frame;
an inner pocket secured to the inner surface of said front cover; said inner pocket being secured to the cover along two edges, and permitting quick insertion of visual material from the other two sides of said pocket; and
an insert having visual information applied thereto in the area within said frame, said insert being in said inner pocket.
